(19) United States
(12) Patent Application Publication
(10) Pub. No.: US 2011/0060775 A1
(43) Pub. Date: Mar. 10, 2011

(54) FILE STORAGE METHOD AND SYSTEM

(75) Inventor: Richard Fitzgerald, Edinburgh (GB)

(73) Assignee: NOKIA CORPORATION, Espoo (FI)

(21) Appl. No.: 12/811,083

(22) PCT Filed: Dec. 22, 2008
(86) PCT No.: PCT/GB2008/004266

§ 371 Date: Nov. 17, 2010

(30) Foreign Application Priority Data
Dec. 28, 2007 (GB) 0725327.1

(51) Int. Cl. G06F 17/30

(52) U.S. Cl. 707/824; 707/E17.01

(57) ABSTRACT

A method and system for storing files in a computer readable format using a file allocation table wherein a storage device is formatted with a single file allocation table when accessed by a system which includes means for reconstituting the file allocation table in the event of a failure. Also provided is a method for determining how many file allocation tables to write to a storage device based on a number of characteristics of the storage device such as type, data structure previously provided on the device etc, and/or on user input.

### TECHNICAL FIELD

This invention relates to the storage of files in a computer readable format and, in particular, to the provision of file allocation tables used for storing computer readable files.

### BACKGROUND TO THE INVENTION

Computing devices use various storage devices to store data. For each storage device, a system is needed so that the computer system is able to find and access the data stored on the device. This system is referred to as a “file system”.

Various kinds of file system are known. For example, the Windows operating systems generally use the FAT (FAT12, FAT16 and FAT32) and NTFS file systems whereas Linux uses the Extended File Systems (ext2, ext3, ext4). The FAT file systems utilise file allocation tables. In this respect, a degree of confusion exists in that the acronym FAT is used in the art to refer to the specific, proprietary file system used by the Windows operating systems as well as to refer to a generic file allocation table. The term “FAT file system” as used herein is used to refer to the Windows specific file system whereas the term “file allocation table” is used to refer to the data structure.

The FAT file systems are described, for example, in the document “Microsoft Extensible Firmware Initiative FAT32 File System Specification. FAT: General Overview of On-Disk Format”, Version 1.03, Dec. 6, 2000; Microsoft Corporation.

The FAT file systems utilise file allocation tables as a directory of the contents of the storage device. The file allocation table defines a singly linked list of the “extents” (clusters) of a file mapped to an identification of a file. Therefore, the operating system of a computing device is able to locate the information of a file on a storage device by referring to a file allocation table.

In the past, each storage device has been provided with two file allocation tables. This has been done to provide redundancy which, it was intended, would improve the reliability of the device.

However, it has been found that the intended reliability is belied by the problem of determining which of the file allocation tables is corrupt if the two tables do not match. Furthermore, maintaining two file allocation tables significantly increases the time used to write data to a storage device and the additional file allocation table utilizes additional storage space.

### SUMMARY OF THE INVENTION

According to a first aspect, the invention provides a system for storing computer accessible files, said system comprising:
a storage device for a computing device, said storage device comprising a file system having one and only one file allocation table and a plurality of files which are accessible by means of the file allocation table; and
restoring means for restoring the file allocation table in the event of a failure.

A single file allocation table significantly reduces the time taken to write information to the storage device, thereby improving the performance of a computing device incorporating a storage device with a single file allocation table. However, to maintain the robustness previously provided by two file allocation tables, the system includes restoring means for restoring the file allocation table in the event of a failure.

The space on the storage device previously used to store the second file allocation table may now be used for data storage, therefore increasing the capacity of the device.

The system may further comprise write means for ensuring safe write operations to the storage device.

The write means may be adapted to ensure sector atomic writes to said storage device.

The storage device may be a NAND flash drive and said write means may then include a device driver and a flash translation layer.

The restoring means may include means for reconstructing the file allocation table from a contents of said files.

The restoring means may include power detection means for indicating an unexpected power interruption to said storage device.

The restoring means may be adapted to restore the file allocation table as a result of the power detection means indicating an unexpected power interruption to said storage device.

The failure may be a failure of the file allocation table. The failure may be detected by detecting a power failure, or by detecting an error in the data stored on the device. In a preferred embodiment; the failure corresponds to a mismatch between the file allocation table and a content of said plurality of files.

The file system is preferably the FAT file system.

According to a further aspect, the invention provides for a method of formatting a storage device with a file system, said file system comprising at least one file allocation table, said method comprising the steps of:
(a) determining one or more characteristics of said storage device;
(b) on the basis of said determined characteristics, determining a number of file allocation tables to be included with said file system; and
(c) constructing a file system on said device, said file system comprising said determined number of file allocation tables.

The file system may be the FAT file system.

The step of determining one or more characteristics of said storage device may include the step of determining a type of the storage device.

The step of determining one or more characteristics of said storage device may include the step of any one of:
determining whether said storage device is removable;
determining whether said storage device is remotely accessible;
determining whether said storage device is adapted to guarantee safe data writes; or
determining whether said storage device is adapted to avoid corrupted sectors.

The step of determining one or more characteristics of said storage device may be based on a data structure with which said storage device is provided.

The storage device may include management software and the step of determining one or more characteristics of said storage device may then be based on whether the management software accesses more than one file allocation table.

The step of determining one or more characteristics of said storage device may be based on whether or not said storage device is shared by more than one operating system.

According to a preferred embodiment, the step of determining one or more characteristics of said storage device comprises the steps of determining whether said device is a fixed flash drive accessed by means of a flash translation layer; and wherein a system utilising said flash drive comprises means for reconstituting said file allocation table in the event of a failure.

Alternatively, the number of file allocation tables may be specified by a user or by a manufacturer of the storage device.

According to a further aspect, the invention provides an operating system arranged to cause a computing device to operate as herein described.

According to a further aspect, the invention provides a computer program or a suite of computer programs suitable for causing a computing device to operate as herein described.

### BRIEF DESCRIPTION OF THE DRAWINGS

Embodiments of the invention will now be described with reference to the accompanying drawings in which:

FIG. 1 is an illustration of a mobile computing device operating in accordance with a preferred embodiment of the invention;

FIG. 2 is a schematic illustration of various components of the mobile computing device of FIG. 1;

FIG. 3 is a schematic illustration of a storage device according to a preferred embodiment of the invention; and

FIG. 4 is a flow chart of a preferred embodiment of the invention.

### DESCRIPTION OF PREFERRED EMBODIMENTS

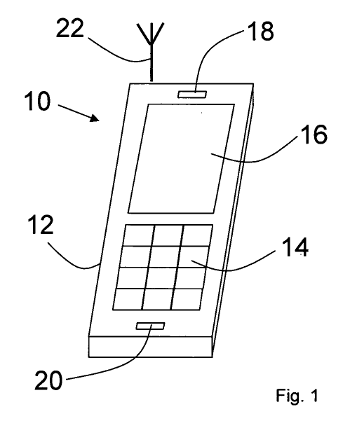

FIG. 1 illustrates a mobile computing device 10 which includes a casing 12, a keypad 14, a screen 16, a speaker 18, a microphone 20 and an antennae 22. The mobile computing device 10 may be used as a mobile phone in a manner known in the art. The keypad 14, screen 16, speaker 18 and microphone 20 are devices and their interactions with one another and with a central processing unit (not shown in the diagrams) is controlled by an operating system. In the embodiment shown, the operating system used is the Symbian operating system produced by Symbian Software Ltd., UK although it will be realised that the invention is not limited in this respect.

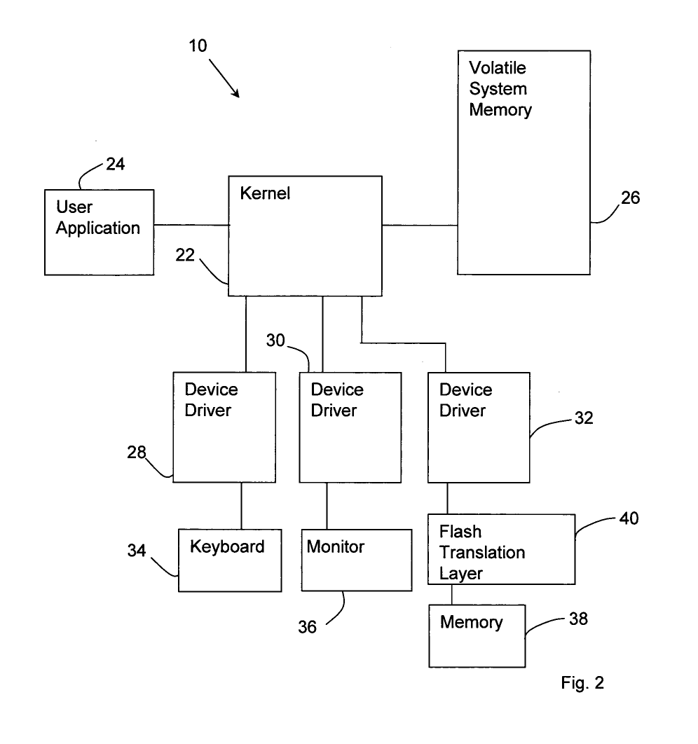

FIG. 2 is a schematic illustration of some components of the mobile computing device 10. The operating system is represented by kernel 22. A user application 24 communicates with the kernel 22 which is connected to system memory 26. Likewise device drivers 28 and 30 are connected to kernel 22 and control the operation of the respective devices: keyboard 34 and monitor 36. Keyboard 34 and monitor 36 are provided by way of example; the device 10 includes a number of additional devices not illustrated in FIG. 2. The kernel 22 controls the operation of the devices 34 and 36 by means of the device drivers 28 and 30 according to the operation of the user application 24, in a known manner.

Device 10 further includes removable non-volatile memory 38 controlled by device driver 32. In the embodiment shown, the non-volatile memory 38 is a NAND flash drive and is controlled by the device driver 32 by means of a flash translation layer 40. Flash translation layer 40 is an application which is loaded by the kernel 12 when the non-volatile flash drive 38 is installed and may, for example, be the Unistore II application. The flash translation layer 40 provides a mapping between the file allocation system used by the operating system and the flash memory 38.

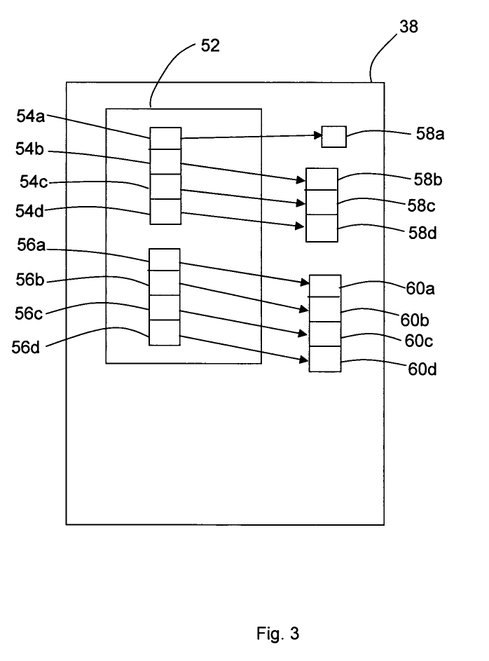

FIG. 3 is a symbolic illustration of the non-volatile memory 38 which includes a single file allocation table 52 and two files. The data on memory 38 has been stored according to the FAT file system. The constituents of each file may, or may not be, stored in a physically contiguous manner. For example, memory 38 includes a first file comprising clusters 58a, 58b, 58c and 58d. As illustrated in FIG. 3, clusters 58b, 58c and 58d are physically contiguous, but cluster 58a is separated from the other clusters. A further file comprises clusters 60a, 60b, 60c and 60d. The file allocation table 52 includes pointers 54a, 54b, 54c and 54d which indicate where in the memory 38 the corresponding data clusters 58a, 58b, 58c and 58d of the first file may be found. Similarly, the file allocation table 52 includes pointers 56a, 56b, 56c and 56d which indicate where in the memory 38 the corresponding data clusters 60a, 60b, 60c and 60d of the second file may be found. Only two files are illustrated in the memory 38 of FIG. 3, but it will be realised that the memory may include many more files, the location for the data of each of which will be specified by the file allocation table.

The physical arrangement of the data on the memory 38 may differ from the structure illustrated in FIG. 3. The flash translation layer 40 acts to ensure that the data structure of the memory 38 appears to the kernel 22 in the manner illustrated in FIG. 3. Furthermore, as the memory 38 is a NAND flash drive, the flash translation layer 40 and the device driver 32 ensure that only sector atomic writes are permitted to the memory 38 by ensuring that no partial sectors are written (for example, an unexpected power interruption will not result in a partial sector being written to the memory 38).

The kernel 22 of the embodiment illustrated uses an application capable of restoring the file allocation table 52 from the contents of the data portions of the memory 38. In the embodiment shown, this application is the ScanDisk application which ships with the Symbian operating system, although other suitable applications exist. Furthermore, the kernel 22 includes a flag (not shown) which is set if the power to the memory 38 has been unexpectedly interrupted. If the kernel boots up and the flag is set, ScanDisk will be automatically run. This will verify that the file allocation table 52 is correct and, if not, fix it. This flag and the ScanDisk application form part of the “Rugged FAT” implementation of Symbian OS. Alternative restoring software for reconstructing the file allocation tables are known, for example, the R-Studio software is capable of restoring the file allocation table and operates on the Windows operating systems, but the same methods may be used with operating systems such as the Symbian OS to restore the file allocation table.

A power fault in the form of a power interruption during a write operation is the most common cause of a corrupted file allocation table. However, other causes of a failure in the file allocation table are possible and may be used to initiate the launch of ScanDisk or the appropriate recovery software. For example, the kernel 22 (FIG. 2) may employ error detection software which verifies the data retrieved from the memory 38. In this instance, if an error is detected, the ScanDisk application will be launched to verify and, if necessary, repair the file allocation table of memory 38. Generally, the failure will arise where there is a mismatch between the file allocation table of memory 38 and the data stored on the memory.

The file allocation table will be restored by analysing the contents of the data portion of the storage device. With reference to FIG. 3, the data portion is the clusters 58a to 58d and 60a to 60d. By analysing the data portions, the recovery software will be able to determine which file(s) each cluster belongs to, and by maintaining a record of the physical position of each cluster, the recovery software is able to reconstitute the file allocation table.

As previously mentioned, the memory 38 differs from data storage devices known in the art in that it comprises a single file allocation table 52. However, the flash translation layer 40, together with the unexpected power interrupt flag and the ScanDisk utility ensure that a backup version of the file allocation table is not required in this embodiment.

A flash drive constructed according to the invention and using a single file allocation table with a Unistore II™ NAND layer has been found to have a write speed of more than 2 Mbytes/second whereas the same flash drive formatted with two file allocation tables displayed write speeds of about 500 Kbytes/second. Similar results have been found on Scandisk™ SD products.

According to a further aspect, the invention relates to formatting a storage device. The process of formatting involves writing the basic data structure which is to be used to store data on that device. Formatting is carried out by an application interacting with the kernel 22 of FIG. 2. The formatting application is able to set the number of file allocation tables in the storage device in a known manner. However, in certain circumstances, a single file allocation table is required, whereas in other circumstances, two file allocation tables will be required. Therefore the invention further relates to deciding whether one or two file allocation tables are required for a particular storage device.

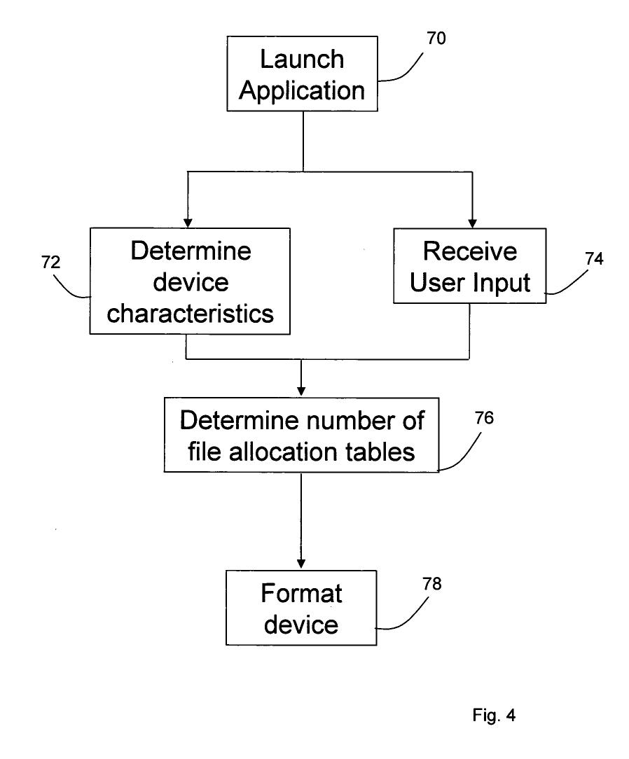

An embodiment of the invention is illustrated in FIG. 4 which illustrates a process for formatting a storage device. In step 70, the formatting application is started. This may occur as a result of a user input, or as a result of a system event such as the installation of the storage device and the detection that the storage device is unformatted.

Steps 72 and 74 represent alternatives. A user may, in step 74, specify the number of file allocation tables with which the storage device is to be formatted. Alternatively, the formatting application will determine a number of characteristics of the storage device in step 72, as described below.

On the basis of either the user input of step 74 or the characteristics determined in step 72, the number of file allocation tables for that storage device are set in step 76. In step 78, the formatting application will format the storage device with the specified number of file allocation tables and with a predetermined file system. In the embodiments discussed herein the file system used is the FAT file system although it is to be realised that this aspect of the invention is equally applicable to other file systems using variable numbers of file allocation tables.

A number of characteristics of the storage device concerned may be determined in step 72 and then used in step 76 to determine the number of file allocation tables with which the storage device is to be formatted. In one embodiment, where the formatting application is operating on a mobile computing device running the Symbian operating system, the formatting application will determine whether or not the storage device is removable, whether the device is a flash drive and whether the system on which the formatting application includes the ScanDisk application. If it is determined that the device drive is a fixed flash drive which is accessed by a flash translation layer and that the system includes the ScanDisk application, the formatting application will format the storage device with a single file allocation table.

In further embodiments the determination of the number of file allocations in step 76 will be based on other characteristics determined in step 72. A number of examples of determined characteristics for a storage device are discussed below. It is to be realised that the formatting application may use each characteristic on its own, or in combination with other characteristics, to determine the number of file allocation tables to write to the storage device. If the characteristics are used in combination, the formatting application could weigh certain determined characteristics in preference to others.

Generally, a determination that the storage device is removable will tend to support the use of two file allocation tables with the device as it is assumed that both are required for the device to be compatible with applications and operating systems expecting two file allocation tables.

If the storage device is shared by more than one operating system running on the same computing device, this would support the use of two file allocation tables on the assumption that the other operating system may require the presence of two file allocation tables.

Furthermore, if the storage device is remotely accessible by a computing device other than the computing device to which the storage device is attached, and the remote operating system is capable of accessing the storage device in a raw format (i.e. without communicating with the operating system of the computing device to which the computing device is connected), it will support the assumption that two file allocation tables will be required.

Further, if the storage device or the system on which the device is installed has no way of avoiding corrupted sectors (which functionality may, depending on device and system, be provided by device access software, or by the device itself) it will support the decision in step 78 to write two file allocation tables to the device.

Alternatively, the decision of how many file allocation tables to include on the storage device is based on a data structure with which said storage device is provided. In other words if the storage device prior to formatting had a single file allocation table, this may be maintained in the formatting. Alternatively, if the storage device was provided with two file allocation tables, this too may be maintained in the subsequent formatting.

Certain storage devices such as flash drives include management software which, for example, ensure write load-balancing across the device. Alternatively, this management software may be incorporated as part of a flash translation layer, or otherwise be provided as part of the device 10, for example. The decision of how many file allocation tables to include may be based on how the management software operates. If this management software accesses two file allocation tables, the storage device will be formatted with two file allocation tables.

However, in a further embodiment, each of the aforementioned considerations may be overridden by a user. The formatting application takes input from a user specifying the number of file allocation tables to use and the storage device is then formatted with the number of file allocation tables.

It is to be realised that the storage device may be formatted at the place of manufacture and in this case, the manufacturer will determine the number of file allocation tables.

In an alternative embodiment, the user's input of step 74 may be combined with the determined characteristics of step 72 so that the user's preference is overridden if it is determined that the storage device has certain characteristics. For example, if the user specifies in step 72 that the storage device is to have a single file allocation table, but the formatting application determines at step 72 that the device is not a flash drive, the formatting application will format the device with two file allocation tables.

1-18. (canceled)

19. A method comprising:
(a) determining a type of a storage device;
(b) on the basis of said determined type, determining a number of file allocation tables to be included with a file system; and
(c) constructing a file system on said storage device, said file system comprising said determined number of file allocation tables.

20. The method according to claim 19 wherein the file system is the FAT file system.

21. The method according to claim 19 wherein determining a type of said storage device includes any one or more of:
determining whether said storage device is removable;
determining whether said storage device is remotely accessible;
determining whether said storage device is adapted to guarantee safe data writes; or
determining whether said storage device is adapted to avoid corrupted sectors.

22. The method according to claim 19 wherein said storage device includes management software and wherein determining a type of said storage device is based on whether the management software accesses more than one file allocation table.

23. The method according to claim 19 wherein determining a type of said storage device is based on whether or not said storage device is shared by more than one operating system.

24. The method according to claim 19 wherein determining a type of said storage device comprises determining whether said device is a fixed flash drive accessed by means of a flash translation layer; and wherein a system utilising said flash drive comprises means for reconstituting said file allocation table in the event of a failure, and wherein said file system is constructed with a single file allocation table.

25. The method according to claim 19 further comprising receiving a user input specifying a number of file allocation tables to be included with said file system.

26. A computer program product comprising a computer-readable medium bearing computer program code embodied therein for use with a computer, the computer program code comprising:
code for determining a type of a storage device;
code for determining, on the basis of said determined type, a number of file allocation tables to be included with a file system; and
code for constructing a file system on said storage device, said file system comprising said determined number of file allocation tables.

27. Apparatus configured to:
(a) determine a type of a storage device;
(b) on the basis of said determined type, determine a number of file allocation tables to be included with a file system; and
(c) construct a file system on said storage device, said file system comprising said determined number of file allocation tables.

28. Apparatus according to claim 27 wherein the file system is the FAT file system.

29. Apparatus according to claim 27 wherein determining a type of said storage device includes any one or more of:
determining whether said storage device is removable;
determining whether said storage device is remotely accessible;
determining whether said storage device is adapted to guarantee safe data writes; or
determining whether said storage device is adapted to avoid corrupted sectors.

30. Apparatus according to claim 27 wherein said storage device includes management software and wherein determining a type of said storage device is based on whether the management software accesses more than one file allocation table.

31. Apparatus according to claim 27 wherein determining a type of said storage device is based on whether or not said storage device is shared by more than one operating system.

32. Apparatus according to claim 27 wherein determining a type of said storage device comprises determining whether said device is a fixed flash drive accessed by means of a flash translation layer; and wherein a system utilising said flash drive comprises means for reconstituting said file allocation table in the event of a failure, and wherein said file system is constructed with a single file allocation table.

33. Apparatus according to claim 27 further configured to receive a user input specifying a number of file allocation tables to be included with said file system.
